(19) United States
(12) Patent Application Publication
(10) Pub. No.: US 2011/0078004 A1
(43) Pub. Date: Mar. 31, 2011

(54) SYSTEMS, METHODS AND APPARATUS FOR SELF DIRECTED INDIVIDUAL CUSTOMER SEGMENTATION AND CUSTOMER REWARDS

(75) Inventor: Daniel R. Swanson, SR., Midlothian, VA (US)

(73) Assignee: Swanson International Inc., Midlothian, VA (US)

(21) Appl. No.: 12/567,029

(22) Filed: Sep. 25, 2009

(51) Int. Cl. G06Q 30/00; G06Q 10/00

(52) U.S. Cl. 705/14.13; 705/14.19; 705/14.23; 705/14.25; 705/14.38

(57) ABSTRACT

A system and method classifies individuals based on product or service preferences of tastes. With input from the system on user preferences, offers are created by product or service promoters specific to a segment of users with similar preferences. The offers, items and users are linked using alphanumeric or digital codes. The offers and the linked codes are used to obtain discounts, rewards and incentives, or warranty registration when products or services are purchased. The offers, linked codes and purchases are stored such that they are accessible by a user.

### BACKGROUND

Nearly all people have a desire to be part of something bigger than themselves. They like to be a part of a group that has similar tastes. As a result people will seek out others like themselves. To use the old adage, “Birds of a feather flock together.” In the past people have been grouped by governments and other organizations by things like race and age. Neither of which a person ever chooses. No individual chooses when they are born, and no one chooses their race. Seldom if ever are people grouped or segmented by their stated preferences and their own stated personal tastes.

Traditionally advertising and promotion has been a “Push” type of communication. This is where the advertising consumer or end user experiences testimonials and advertisements that others have selected for the user. As a result, modern consumers often view promotions, endorsements and advertising as something that impedes them from experiencing the actual content selected by the user.

Traditionally manufacturers, distributers, advertisers, retailers, and other organizations (consumer interested parties) have tried to predict individual consumer behavior. These consumer interested parties want to better understand consumers because it is believed that this understanding can lead to higher sales and greater profits. Because individual behavior is usually difficult to predict, often these organizations have tried to make these predictions by lumping consumers into groups or segments. Almost always these classification segments are unknown to the consumer. Often these classifications are not completely accurate for any given consumer and almost always miss nuances of preferences that individual consumers have.

Presently there is no known way for an individual to understand their current personal purchasing behavior and how it relates to the often “secret” segmentation group into which they have been cast by a consumer interested party. This may lead to consumer frustration and consumer distrust.

Today there are millions of products and services offered worldwide. During an individual's lifetime he may not have enough time to easily identify products or services that he may like without trying a number of these products personally. Product reviewers have helped this problem somewhat. However, a consumer may still have difficulty in finding a reviewer with similar tastes and preferences. For instance, a restaurant reviewer may love a restaurant and recommend it highly. A consumer may see the review and try the restaurant only to find the food not at all to the consumer's taste. This causes lost time, increased cost and disappointment for the consumer.

### BRIEF DESCRIPTION OF THE DRAWINGS

FIG. 1 illustrates a system environment in accordance with an example embodiment;

FIG. 2 illustrates a block diagram for determining individual customer segmentation and customer rewards;

FIG. 3 illustrates an example individual customer segmentation and customer rewards determination system;

FIG. 4 illustrates an example Segment Administration module;

FIG. 5 illustrates an example process for developing and utilizing individual segmentation;

FIG. 6 illustrates examples of user specific segmentations;

FIG. 7 illustrates an example of a segmentation output;

FIG. 8 illustrates an example of potential aspirational segmentations available to a specific user;

FIG. 9 illustrates an example process to create discounts and incentives for a segmentation;

FIG. 10 illustrates and example of differentiated discounts by segment;

FIG. 11 illustrates two examples of discount code creation;

FIG. 12 illustrates an example process to build and maintain a aspirational segmentation;

FIG. 13 illustrates an example process to utilize a segmentation code to obtain a discount or incentive;

FIG. 14 illustrates an example process using a code which also initiates payment for a good or service;

FIG. 15 illustrates an example results module;

FIG. 16 illustrates an example process to enable a customer warranty;

FIG. 17 illustrates an example of consolidated discounts;

FIG. 18 illustrates an example process for providing anonymous feedback in order to receive a reward;

FIG. 19 is a block diagram of a computer system for executing methods of various embodiments;

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims. The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system. The software may be executed on a plurality of digital signal processors.

Currently there exists no known way for a consumer to know which reviewers are truly like themselves. As a result, the consumer must compare the reviewer's tastes to his or her own tastes, over time, to make sure the reviewer is actually enough like the consumer for the reviews to be valid. This may lead to lost time and consumer frustration.

While consumer tastes are different, consumers in different life stages have different needs too. Consumer behavior is also frequently changing as individual consumers move over the years through various lifestyle and consumption patterns. The consumer that is just married with no children will have dramatically different purchasing habits and interests than the same consumer will have when he or she has small preschool age children. Likewise consumers with elementary school age children have still different purchasing habits and interests. Differences can also be seen in consumers with middle school, high school, and college age children. These differences are even greater when the consumer finds their children have grown.

All consumers, childless or with children, may find their behavior changes as they age and acquire new jobs, or new interests. Often consumers aspire to new behaviors, that may even be driven by aspirational lifestyles or aspirational locations. A consumer simply may want to be different tomorrow than they are today or were in the past. This may cause difficulties for the consumer because the new aspirational lifestyle and the subsequent aspirational purchasing behaviors are unknown to the consumer. In other words “it's hard to get somewhere if you don't know where you are going.”

Presently there is no known way for a consumer to identify, build and then follow a path toward an aspirational lifestyle and the subsequent aspirational purchases. This leads to lost time and significant consumer frustration. As a result there exists a need to enable consumers to identify other consumers with similar tastes to the consumer's aspirational tastes.

Consumers would benefit from a system, method and apparatus that enable them to identify their own personal tastes in products, opinions and services and compare these personal tastes to those of others.

Additionally, consumers would benefit from identifying a segment of other customers that is largely similar to themselves. With such information they could facilitate an increased understanding of products and services that they may have not tried previously but that are highly regarded by consumers with whom they are similar. The consumer may thereby direct their own purchases toward product and services that others, in the similar segment, value or recommend.

Moreover, consumers, through an increased understanding of segment preferences other than their own, would benefit by identifying, considering and even purchasing products and services favored by segments to which they aspire. When consumers understand the preferences of an aspirational segment they can shorten the research time necessary for new products and services. As a result, they will make fewer wrong purchases, which will in turn, save them time and money.

Various embodiments relate to self directed individual customer segmentation and customer rewards, which may utilize many different media, including, but not limited to, ink and paper, sound or visual image, music, motion pictures, radio and television broadcasting, a network, and the internet. More particularly, apparatus, systems and methods are provided for identifying, valuing, rating, measuring, individual customer segmentation, creating metrics and providing customer rewards and the reporting on metrics obtained, and improving on the products and services identified or acquired by using the invention.

Various embodiments may be used by one or a plurality of individuals, including but not limited to individuals who wish to: understand the consumer segmentation process, purchase a good, purchase a service, understand what products and services other individuals like themselves highly regard, understand what products and services other individuals unlike themselves highly regard, identify aspirational lifestyles, identify products and services that individuals from aspirational lifestyles highly regard, receive discounts on goods and services that the individual wants, receive incentives and rewards from companies that build, distribute or sell products and services that the individual wants, help manufacturers or providers create products and services that are highly valued by the individual, help manufacturers or providers improve on existing products and services that are highly valued by the individual, help manufacturers or providers evaluate existing products and services that are not highly valued by the individual, register product warranties, receive rewards for helping manufacturers and others better understand and predict individual and segment purchasing patterns.

Presently, there is no known way to help an individual consumer compare their own product and services tastes with other unknown individuals who have similar tastes. Presently, there is also no known way to help the individual consumer identify aspirational lifestyles and aspirational products and services with other unknown individuals who are currently living, or wish to be living, the aspirational lifestyle. As a result, the individual consumer may not select the products and services that will be most satisfying and potentially most beneficial to the individual consumer. As a result, an individual's life experience may be suboptimal. In addition, time and money will be wasted purchasing products and services that will not satisfy the individual consumer's tastes. The term “promoter” is used to represent manufacturers, distributers, advertisers, retailers and other consumer interested parties that promote products or services.

Through a new system, method and apparatus, the individual benefits by a better understanding of his or her own tastes and preferences and how these relate to others. Some embodiments may also reduce household expenditures and save users money by enabling them to more quickly identify products and services that will have a higher propensity to satisfy their individual tastes. Some embodiments may also help reduce consumer costs by providing discounts, incentives and rewards for products that they prefer and products they buy.

A promoter (manufacturing, distribution, advertising, service or retail organization) may benefit by being able to more effectively select, improve and promote the right product or service to the right individual or group of individuals. This reduces the potential problems that may arise from over mass advertising. With current methods of mass advertising, a very costly advertising campaign is developed and deployed that will most often only reach a very small percentage of people who are actually interested in purchasing the good or service. In some cases the group of potential purchasers is less than 1 percent of the total audience reached. Current methods of mass promotion and advertising thus waste millions of dollars each year. Some embodiments described herein may help ensure the success of product and service promotional efforts by better enabling the matching of the right promotion or offer to the right individual.

Even current so-called, “targeted advertising” is actually only targeted to a group of individuals. Most often this “targeting” is based on assumptions. Assumptions are often made based on aspects of an individual that the individual cannot control such as age or race. Generally this type of targeting looks for a common thread that is shared by a group of individuals.

Advertisements are “targeted” toward individuals based on assumptions of others. These assumptions may be made by people, or they may be made by systems and methods. Current targeted ads are based on what some person or some system believes a customer wants, rather than being based on what the customer really prefers. This is inefficient because advertisers are not getting qualified leads of people interested in their specific product or service. With current method, this broad brush stroke reaches potentially thousands of people, but only a few may even have an interest in the advertiser's product or service. This wastes money. By using this invention advertisers could save millions of dollars which are wasted on so-called “targeted advertising” and spend fewer dollars reaching customers with a genuine self-directed interest.

Because a customer encountering a new product or service may not know anything about that product, with current systems and processes it would be nearly impossible to know if the customer will prefer or enjoy the product. Current targeted advertisements do not take into consideration individual consumer preferences. As a result trial and error is all that current customers have when they experience a new product. Individual consumers need the ability to access promotions that are based on their individual preferences or tastes, or targeted to them as part of a segment that they have freely and willingly joined. Some embodiments will make consumers happier since they will only see offers, promotions and advertisements that have a high propensity to satisfy them as individuals. Products promoted based on information from current systems has a much lower propensity to satisfy a customer because the customers true wishes and tastes were not considered.

A promoter (manufacturing, distribution, advertiser, service or retail organization) will also benefit by being able to more effectively improve the right product or service to the right individual or group of individuals. Since unique purchase offers may be linked to specific individuals and may also be linked to promotional efforts, one skilled in the art will recognize that metrics generated by the system may be linked to individuals and also to segments. This linking will enable a more effective product ownership registration method and product feedback method than currently exists. With product registration and improved feedback an organization will be able to gather information on which features of the product or service need improvement to meet and individual's or segment's needs.

Successful, efficient innovation efforts also help society at large, by enabling enhancements to, or enabling the invention of, products, processes and services that help improve the quality of life for people. With all the advantages of improving the efficiency and output of self directed individual customer segmentation and customer rewards efforts, it is clear that a system method and apparatus that helps facilitate customer satisfaction would be very valuable.

A system, method and apparatus provides special discounts, incentive and/or rewards and tailoring of promotions and advertisements (hereafter called offers) to individuals over a networked media delivery system. Broadly stated, the system allows a user to specify properties of products or services that are of interest to said user. These user defined properties may be combined with inputs from other unknown or known users and from promoters to determine the offer. The offer is intelligently categorized and delivered into content as appropriate. The offer may be delivered to an individual profile or a segment profile as needed. Systems and methods for valuing and tailoring promotional discounts and rewards and the placing said promotional discounts and rewards into media content as a result of the offer are provided. Further, various embodiments provide valuable feedback to promoters, advertisers and others by identifying important opportunities for improved offers and improved products and services.

Some embodiments may deliver different offers to different users who are viewing (or using) the same content at the same time. Such content may be description or review of a product or service. In addition, the same offers may be delivered to different users at different time periods. Because individual offers may be used, there is almost no limit to the potential combination of users, advertisements, promotional discounts and/or rewards that can be effectively serviced.

In one embodiment, a plurality of inputs is brought together with a communication network into a self directed individual customer segmentation and customer rewards system. Using these inputs, an offer is calculated for each product and service, the offer may be categorized and are then stored either locally or remotely to a user's output device, as content is delivered to the output device, the self directed individual customer segmentation and customer rewards system selects and places appropriate offers in appropriate formats. Results of customer offer usage are then gathered, reported and consolidated to document the promoter's reach and potential impact. This information may then be shared with promoters, advertisers, content providers, and users. Various embodiments are designed to help ensure users will receive advertisements and offers that are valuable to them and at the same time, advertisers will know that their advertisements are reaching potential customers instead of merely the mass market.

Such offers may be deployed in a number of media including, but not limited to, television, radio, game system, cellular phone advertising, email, internet and potentially any advertising method where an individual is the consumer of the advertisement.

In one embodiment, the preferences or results of an individual are passed to third party systems. In this manner third party systems may utilize information from preferences and results for creating or modifying additional offers or benefits for an individual. This may be done with the individual's permission.

In another embodiment, segment preferences or results may be passed to third party systems. Third party systems may utilize this information for creating or modifying additional offers or benefits for a segment. All personally identifiable information may be removed from the segment information.

In another embodiment, external parties such as, retailers, wholesalers, manufacturers etc., may pass information on product in-stock conditions to the systems. This may include information on product location. This information may be used by the system to identify stores where a desired product is in stock. This information may also be used to set aside product for individual customers who wish to purchase the product. This information may be used to reserve products or services for individual customers.

Further features and potential advantages as well as the structure of operation of various embodiments are described in the following text which includes detailed descriptions and figures.

It is to be understood that both the foregoing general descriptions and the following detailed description are examples and explanatory only, and should not be considered restrictive of the scope of the invention, as described and claimed.

Further, features and/or variations may be provided in addition to those set forth herein. For example, embodiments of the invention may be directed to various combinations and sub-combinations of the features described in the detailed description.

A description of the various embodiments follows. As an overview, embodiments of the systems and methods of self directed individual customer segmentation and customer rewards system consistent with the present invention take inputs from one or a plurality of sources. These inputs are used to determine an appropriate offer of a product or service for the individual user and a user segment. This item level offer may then be used to categorize a promotion or an advertisement into one or a plurality of offer groups. As the user selects content, specific offers from the offer groups are placed in the content at appropriate points. The result of this tailored offer is gathered, processed and stored to facilitate reporting to manufacturers, retailers, promoters, advertisers, sellers, content providers or users. In one embodiment, personally identifiable information such as name, address, age, sex, additional channels viewed and other information, may only be gathered and reported if a user voluntarily agrees to attach this information. The user may volunteer this information as a part of their desire to have contact from a promoter, or for some other personal reason the user may have.

The system can be implemented over a variety of multimedia networks with large populations of network devices including but not limited to: computers, televisions, television cable, satellite and set top boxes, game consoles, cell phones, portable data access devices, email, computers, radio, and other network apparatus or appliances.

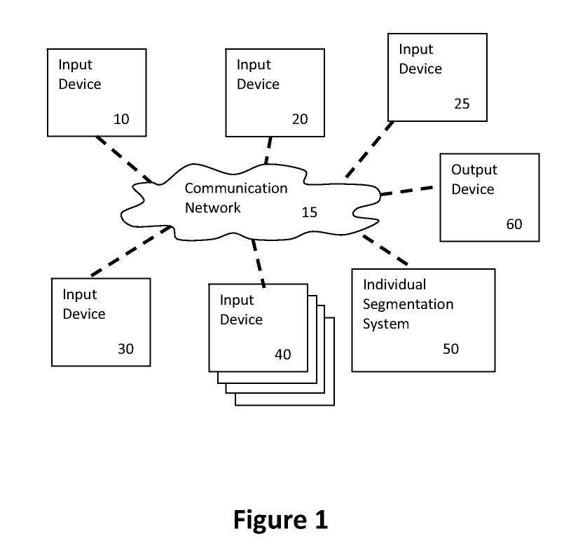

FIG. 1 illustrates an example device or system having several components including input devices that communicate via a network 15. Such a network may be a wired network or a wireless network. Input device 10 may be a laptop, handheld device or desktop computer that enables a user to make preference selections. Input device 20 may be any compatible input device from one or a plurality of content providers that supply content. Input device 25 may be any compatible input device from a retailer system including a Point of Sale system, which may communicate with the network and pass transaction information to the network. Input device 25 may also communicate product quantity, in-stock conditions, and product location to the network.

Communication network 15 enables a plurality of input devices to communicate. Input device 30 may be any compatible input device from one or a plurality of manufacturers, distributers, product sellers, promoters or advertisement providers. Input device 30 may also communicate product details, product quantity, in-stock conditions, and product location to the network. Input device 40 may be any compatible input device from a plurality of additional possible input devices, which include but are not limited to, television or set-top TV box remote controls, satellite remote controls, cell phones, telephones, Personal Digital Assistants, or any other wireless or wired device that has the ability to make selections and link to a network.

Individual Segmentation System 50 gathers information from one or a plurality of input devices, calculates an offer for product or service, and then selectively places advertisements and or offers within the defined segmentations. The placement of the offers and advertisements are recorded. Metrics on the offers and advertisements placement are reported as appropriate. Output device 60 is the device by which the content, offers and advertisements are experienced. These may include but are not limited to, computers, printers, televisions, cell phones, portable data access devices, email, radio, Point of Sale (POS) systems, and other network apparatus or appliances.

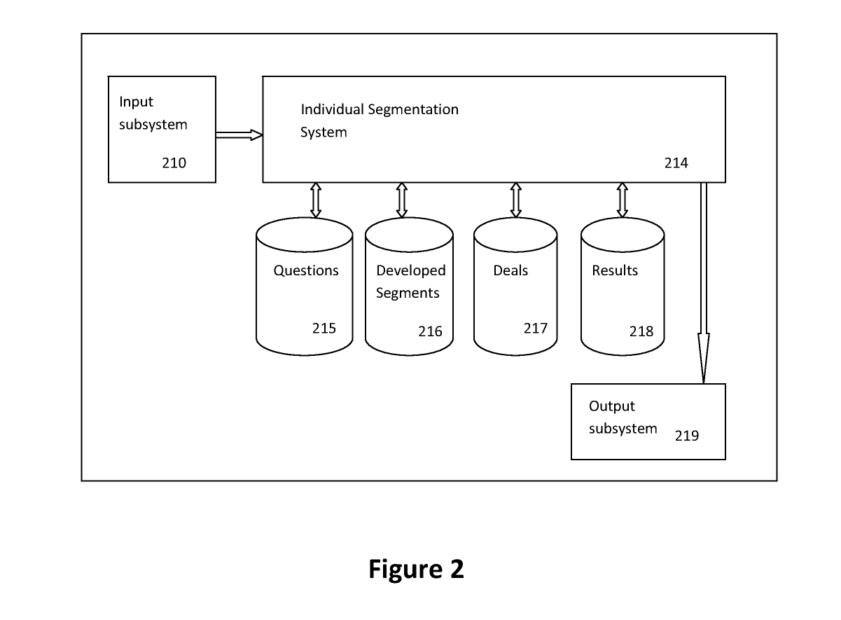

FIG. 2 illustrates the components used by the Individual Segmentation System 214. Input Subsystems 210 may be at least one of the following, a keyboard, a website, a remote control device, a broadcast signal, a satellite feed, a cable TV feed, a Virtual Private Network (VPN), a Bluetooth device, a personal digital assistant PDA, a Voice activated response (VAR) system, Voice Response unit (VRU), a cellular or mobile phone voice system, a cellular or mobile phone Short Message Service (SMS) system,. These inputs may come from diverse and even encrypted sources. Individual Segmentation System 214 decodes inputs into a format usable by the Individual Segmentation System 214.

In one embodiment, using input subsystem 210, the Individual Segmentation System 214 takes user responses to product, service, personality and lifestyle preference questions from Questions 215, and uses matching calculations, to identify at least one or a plurality of similar previously developed segments from Developed Segments 216 for the user. Individual Segmentation System 214 then directs these recommendations to Output subsystem 219. Output subsystem 219 may include but is not limited to, computers, computer monitors, PDA's, printers, television monitors, radios, computer projectors, emails, cell phone screens, phone screens.

In another embodiment, input subsystem 210 provides transaction data from retailers, or other transaction sources. The Individual Segmentation System 214 takes transaction data and combines it with user responses to product, service, personality and lifestyle preference questions from Questions 215, and uses matching calculations, to identify at least one or a plurality of similar previously developed segments from Developed Segments 216 for the user. Transaction data may be stored in results 218.

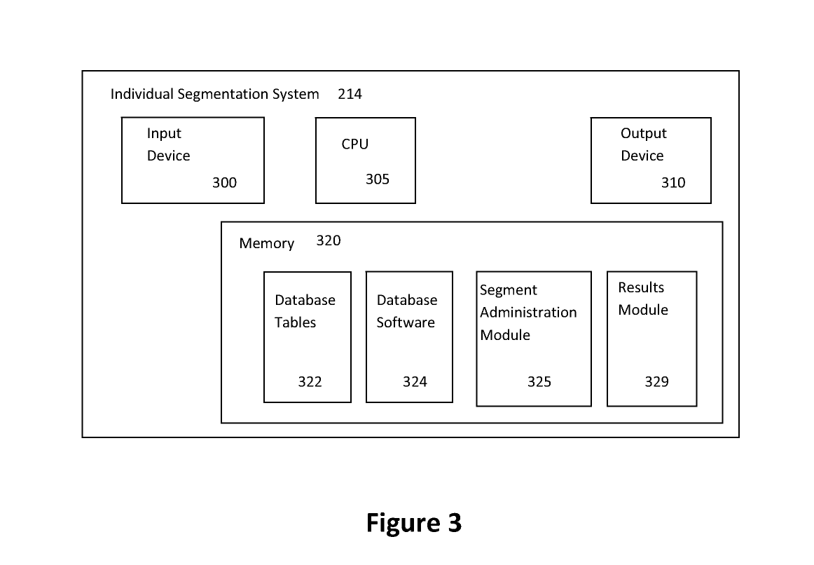

The Individual Segmentation System 214 may assign offers (product and/or services discounts and rewards) to Developed Segments 216 using the Deals 217, previous Developed Segments 216, and user responses from Questions 215. Offers may include offer codes that are stored in Deals 217 by segment. The Individual Segmentation System 214 places the offers and promotions appropriately using Segment Administration Module 325 (FIG. 3). Offers, offer codes, advertisements and promotions are presented to output subsystems 219 in content distribution.

During content distribution, Individual Segmentation System 214, accesses offers, offer codes and other pertinent information regarding promoter deals from Deals 217 and places the offers, offer codes, advertisements and promotions in content. Content placement may also include output of segment reports, reports on deals, usage rates, results, feedback, or others.

Placement is captured in Results 218. In addition, any rating the user may give products, services, promotions or viewed advertisements, may also be added to Results 218.

To report on metrics and provide feedback to product and services providers, advertisers and content providers, Individual Segmentation System 214 may report information from Results 218 as appropriate. Metrics are directed to Output subsystems 219, which may include but are not limited to, networks, computers, computer monitors, printers, television monitors, radios, PDA's, computer projectors, emails, cell phone screens, and phone screens.

FIG. 3 is a block diagram illustrating an example Individual Segmentation System 214. Individual Segmentation System 214 may be any general-purpose computing system using Linux, Unix, Windows, Apple or any operating system In any case, such a system may have at least one Input Device 300 which may include network interfaces, keyboards, mice, speech recognition devices, video, or image input devices, remote control devices, a broadcast input interface, a satellite input interface, or a cable TV input interface. Additionally, Individual Segmentation System 214 may have at least one output device 310, such as, display devices, network interfaces, printers, or sound or speech output devices to name just a few.

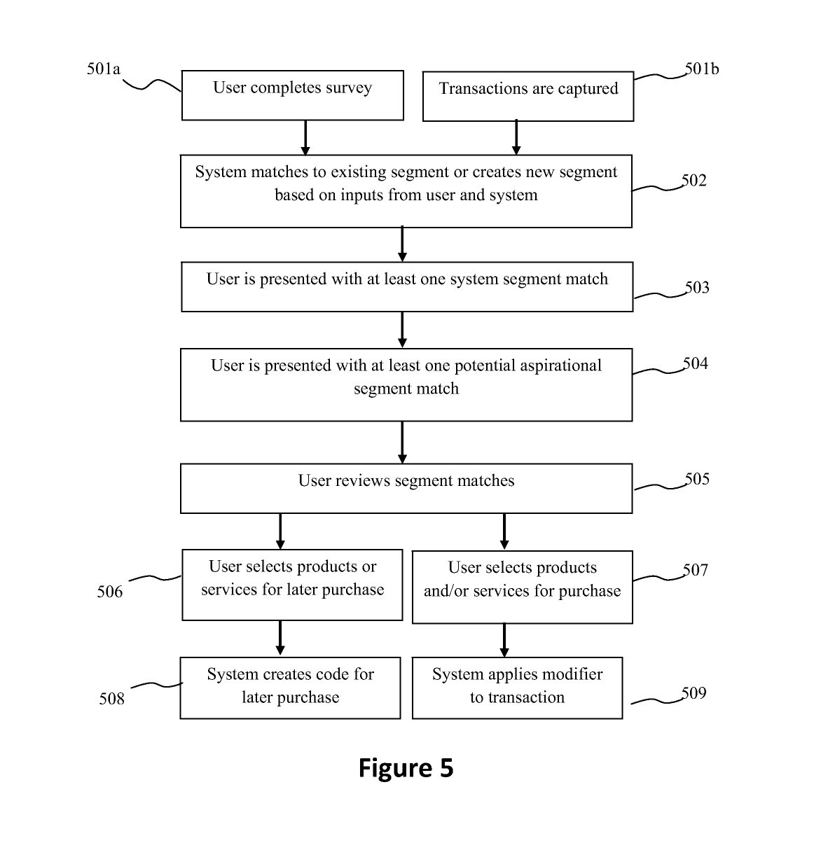

At least one central processing unit (“CPU”) 305 will be used in Individual Segmentation System 214. CPU 305 may execute software programs for implementing the processes described below with respect to FIGS. 5, 9, 12, 13, 14, 16, 19. One skilled in the art will appreciate that although FIG. 3 shows one CPU, multiple CPUs may execute the Segment Administration Module 325 and the Results Module 329, along with the Database Software 324, and Database Tables 322. The Segment Administration Module 325 processes the various inputs, determines the offers (product and/or services discounts and/or rewards) by product, and then places offers in appropriate segments (categories) relating to the user's preferences. In one embodiment, categorization grouping is unlimited for offers and advertisements.

As a user selects content, the Segment Administration Module 325 evaluates the selected content which may be in real time, and then places an appropriately identified offer for each product or service.

Memory 320 may also contain Results Module 329, which may process advertisement placement details such as date and time of placement, customer's ratings, and any customer information that is voluntarily given. Results Module 329 may also consolidate results and calculate product, service or advertising measures as needed to provide adequate feedback to users, advertisers, advertising agencies, product or service providers, and content providers. These software programs may reside in Memory 320 of Individual Segmentation System 214. In addition, Memory 320 may include Database Tables 322 comprising records, such as, personality traits, likes and dislikes, individual product and service preferences, reviews and/or ratings, segment product and service preferences reviews and/or ratings, previously highly valued products, account transaction records, etc. Memory 305 may include Database Software 324 for manipulating the records of Database Tables 322.

In one embodiment, software 324 may interact with various modules (described below) stored in memory 320 to process records stored in database tables 322. Thus, for example, software 324 may be a relational database software which may interface with any software module or program that may query, sort, segment, or, create, manipulate or modify offers, or evaluate personality or preferences, or create, manipulate or modify lifestyle or aspirational paths by processing records stored in database tables 322. One skilled in the art will appreciate that any object oriented techniques or other computational techniques may also be used to manipulate records stored in database tables 322. Indeed based on object oriented techniques, records stored in database tables 322 may be represented as objects and may not be stored as part of any table. In other words, database tables 322 and software 324 are merely one example, and records or equivalents thereof, may be processed using other known computing techniques and arrangements.

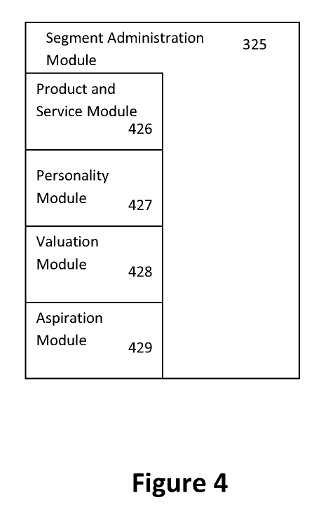

FIG. 4 illustrates one example sub-modules of Segment Administration Module 325. Segment Administration Module 325 may further include Product and Service Module 426 which uses inputs to create, modify and maintain item level information, Personality Module 427 which uses inputs to help identify an individual's personality and preferences, Valuation module 428 which may use inputs to help determine segment and individual, item level offers (product and/or services discounts and/or rewards) and Aspiration Module 429 which uses inputs to help identify, monitor and maintain potential aspirational lifestyles segments for segments and individuals. Each of these modules may be implemented in software, firmware, hardware, or any combination thereof. Further, although FIG. 4 shows four different modules, they may be combined in any fashion and may be located on the same system or implemented across a distributed computing system.

FIG. 5 illustrates an example process for creating a segmentation for a user. A single individual may have a plurality of classifications, or segments available to him as a result of his responses to a segmentation survey and transactions. In one embodiment, a user completes as much of survey 501a as user desires with the understanding that the more questions a user completes, the more accurate the segmentation matches may be. Various embodiments utilize a segmentation model that is substantially different than current segmentation models. Current models often group people by race and or age. Since an individual has no control over their age or race, in one embodiment, users are not queried with questions regarding race or age.

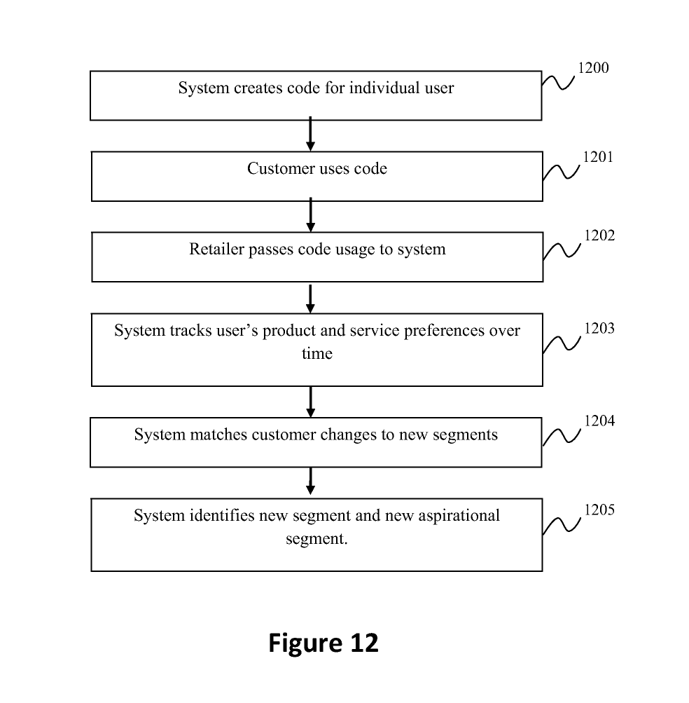

In another embodiment transactions are captured 501b by Individual Segmentation System 214 (FIG. 2). These transactions help identify individual preferences by documenting purchases. Another embodiment is discussed in FIG. 12. The system matches 502 user responses to existing segments found in Segment Administration Module 325 (FIG. 3). In one embodiment, if the user's preferences are significantly different than all the segments in the Segment Administration Module 325 (FIG. 3) the process may create a new segment based on inputs from user and may include input from personality module 427, Product and Service module 426, and Aspirational module 429 (FIG. 4). The user is presented 503 (FIG. 5) with at least one segment or a plurality of segments that the system has identified is most currently similar to the user.

The user is also presented 504 with at least one potential aspirational match. In one embodiment, aspirational matches show potential future segment matches for the individual. Aspirational matches enable the user to see segments comprised of people who may share their tastes at some point in the future.

The user reviews 505 the various segment matches. In one embodiment these matches contain offers for products and services from matched or aspirational segments. In another embodiment these matches contain product and service reviews from individuals in system matched similar or aspirational segments. In yet another embodiment these matches contain personality profiles of representative segment members. In another embodiment personality profiles and product reviews may not be personally identifiable.

User selects products for later purchase 506. Based on the users selections system creates at least one code for a later purchase 508. In one embodiment, the system creates codes for products and/or services discounts that may be used at a point of sale device at a later time. In one embodiment, the system creates codes for products and/or services rewards that may be used at a point of sale device at a later time. In one embodiment, the system creates codes for products and/or services rewards that may be used at a time irrespective of a point of sale purchase being made. These codes may be machine readable by any of the following methods including but not limited to; bar codes, infrared codes, audio codes, wireless digital codes, RFID codes, magnetically encoded codes, pen and paper codes.

The user may have an immediate need to purchase a good or service after user reviews matches 505. In one embodiment user selects products and/or services for purchase 507 with the intent to quickly purchase the selected product and/or service. System immediately applies a modifier (a discount) 509 to the purchase transaction. In another embodiment, user selects products and/or services for purchase 507 with the intent to quickly purchase the selected product or service. System immediately applies a modifier (a reward) 509 to the purchase transaction. Rewards may include but are not limited too; cash rebates paid immediately to a designated account, cash rebates paid at a future date to a designated account, rebate check sent to a designated address, credit rebates paid immediately to a designated account, credit rebates paid at a future date to a designated account, savings bond reward, additional merchandise reward, gift with purchase reward, buy one get one free reward, or buy one get one at a discounted price percentage.

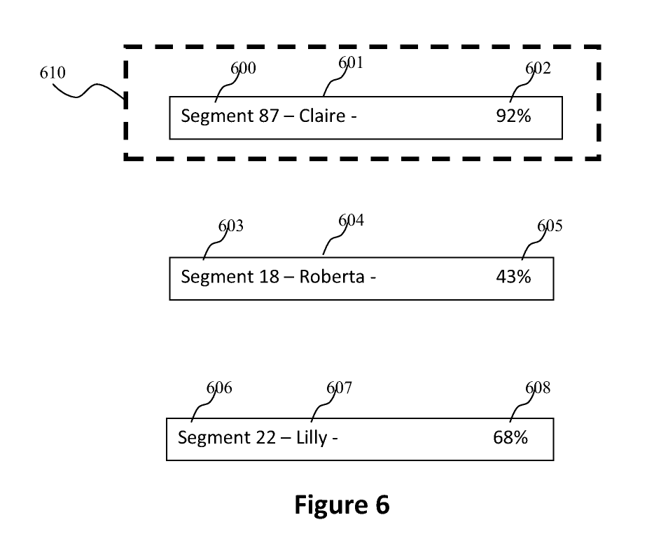

FIG. 6 illustrates an example segmentation presentation created by Individual Segmentation System 214 (FIG. 2). There is no limit to the number of segments that may be created and maintained by Individual Segmentation System 214. In this example user has completed survey 501a (FIG. 5) and the system has used the Database Tables 322 (FIG. 3), Database Software 324, and Segment Administration Module 325, to identify and present 3 potential matches to the user. Segment 87 (600) (FIG. 6) is the system created number assigned to this representative segment. In one embodiment segments have personal names to facilitate user's memory of the segment. Claire (601) is such a name. This name may have no relationship to the user other than to facilitate memory. From the user's responses the system has matched 92% (602) of users survey answers to this segment designated Segment 87—Claire.

In addition two more segments have been matched to the user's survey responses. Segment 18 (603) Roberta (604) was matched to 43% (605) of the user's survey responses. Segment 22 (606) Lilly (607) was matched to 68% (608) of the user's survey responses. In one embodiment user makes the final decision as to which profile is in fact most closely matched to user's own personal tastes and preferences. In this example, user reviewed all three profiles and then selected 610 as most closely matching users tastes and preferences. In this example user selected the segment that the system most closely matched to user 92% (602). However, in one embodiment user may select any of the profiles presented to user without regard as to the level of system match.

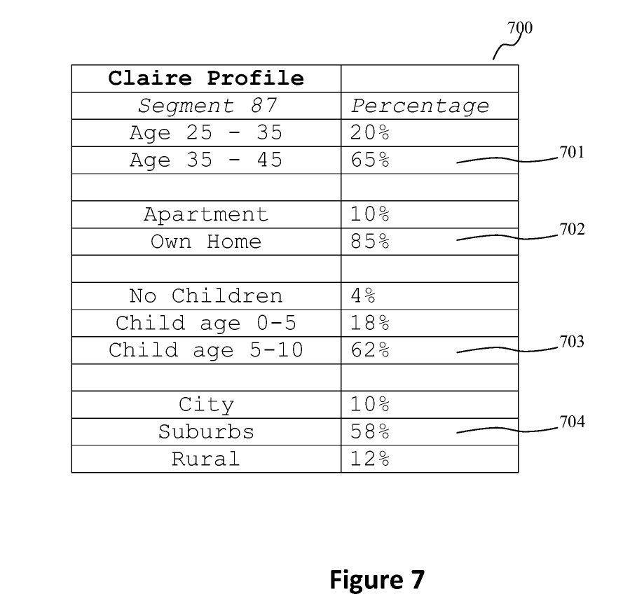

FIG. 7 illustrates an example segmentation profile overview FIG. 7 is a continuation of the FIG. 6 example. In the detailed description of FIG. 6 user selected the Claire profile after reviewing each of the profiles presented. In this embodiment, a brief summary of the Claire profile 700 provides more detail of the segment. The Claire profile here illustrates that 65% of the individuals currently comprising the profile are between the ages of 35 and 45 (701), the profile summary may also describe what other ages are contained in the profile. The Claire profile here illustrates that 85% of the individuals currently comprising the profile own their home (702), the profile summary may also describe what other housing arrangements are contained in the profile. The Claire profile here illustrates that 62% of the individuals currently comprising the profile have at least one child aged 5-10(703), the profile summary may also describe what other household members are contained in the profile. The Claire profile here illustrates that 58% of the individuals currently comprising the profile live in the suburbs (704), the profile summary may also designate where other profile members may live.

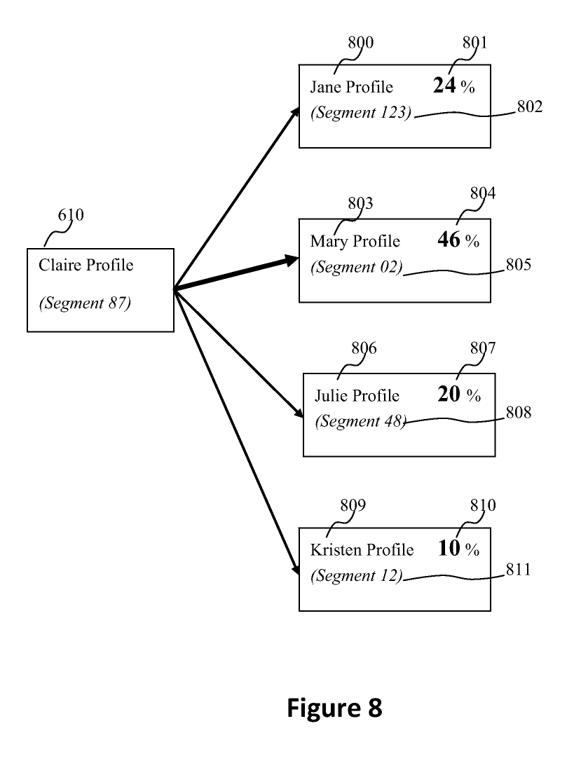

In addition to presenting a user with segments that are currently similar to a user's tastes and preferences a feature of this invention is the ability to identify aspirational preference or lifestyle segments to which a user may eventually migrate. FIG. 8 illustrates an example aspirational segment profile. In this illustration FIG. 8 builds upon FIG. 6 and FIG. 7 and uses the previously identified Claire Profile 610 as the current best segment match for the user.

In this embodiment, the Individual Segmentation System has identified aspirational segments, based on the actual movement of previous Claire Profile 610 users. This illustration shows the percentage of previous Claire Profile 610 users into each of the respective aspirational segments. In this illustration there are four potential aspirational segments. However, various embodiments may provide at least one aspirational segment or a plurality of aspirational segments. The number of potential aspirational segments is unlimited. Of the four aspirational segments in FIG. 8, the Jane profile 800 received 24% 801 of previous Claire profile 610 users, the Mary Profile 803 received 46% 804 of previous Claire profile 610 users, the Julie Profile 806 received 20% 807 of previous Claire profile 610 users, the Kristen Profile 809 received 10% 810 of previous Claire profile 610 users. For this example 100% of previous Claire profile 610 segment users can be accounted for in these four aspirational segments. The new Claire profile 610 user may then review each of the four segments to determine which aspirational profile is most like the new Claire profile 610 user. The new Claire profile 610 user may initially be interested in reviewing the Mary Profile 803 because it accounts for the greatest number 46% 804 of previous Claire Profile 610 users. However, the new Claire profile 610 user may review and even identify with any of the aspirational segments.

In this FIG. 8 embodiment, each segment has a name and a segment number to help facilitate user identification The Jane Profile 800 may also be identified as (Segment 123) 802. The Mary Profile 803 may also be identified as (Segment 02) 805, the Julie Profile 806 may also be identified as (Segment 48) 808, the Kristen Profile 809 may also be identified as (Segment 12) 811.

In one embodiment, aspirational segments are created by observing users preferences over time and recording migrations from one user segment to another. In another embodiment users are asked survey questions in 501a (FIG. 5) that inquire as to where the user would like to be at a certain time period in the future such as two, five or seven years. In yet another embodiment, a mathematical algorithm predicts future aspirational migrations based on a series of user life events. This algorithm may then direct the user towards even more specific aspirational profiles.

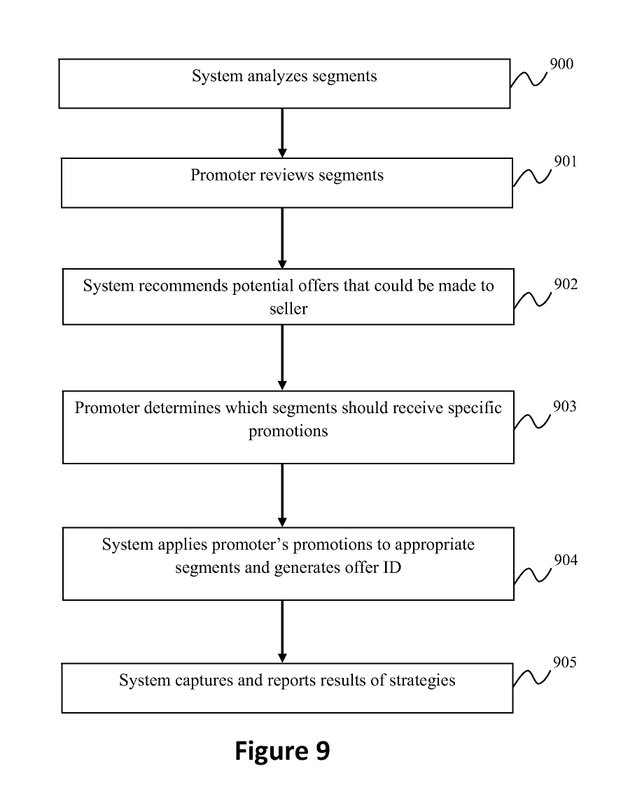

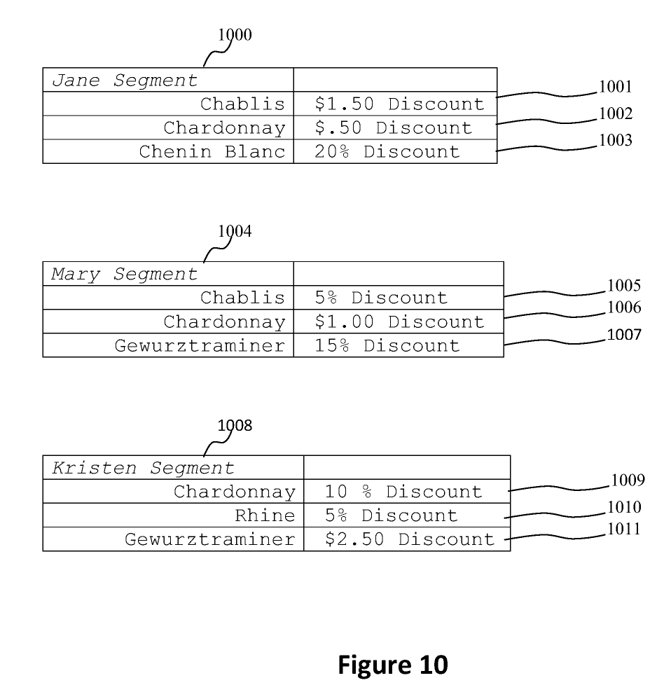

FIG. 9 illustrates an example process for creating a segmentation offer for a user For the Individual Segmentation, the System analyzes segments 900 to determine if opportunities exist for creating offers for specific segments. In one embodiment, the system runs an analysis continually looking for offer opportunities. In another embodiment the system runs an analysis at a predetermined time. In another embodiment the system runs an analysis only upon request from a third party individual or third party system. An illustration of this will be found in the detailed description of FIG. 10. Generally, each consumer interested party will have specific products or services to promote. Not all promoters will have the same items of interest. The promoter reviews segments 901 (FIG. 9) to determine which segments may be of interest. The promoter selects his or her areas of interest. Some promoters may be interested in specific products or services. Others may be interested in entire categories or lines of products. Still other promoters will be interested in entire industries. Yet other promoters will be interested in one or a plurality of services. Various embodiments may provide recommendations 902 for potential offers to whatever depth or breadth of product or services the promoter wishes to review. In one embodiment recommendation 902 is based on current documented buying behaviors of users. In another embodiment recommendation 902 is based on forecasted buying behavior.

In yet another embodiment recommendation 902 is based on at least one or a plurality of inputs, which may include but not limited to; current segment user likes, current segment user dislikes, aspirational segment likes, aspirational segment dislikes, segment summarized personality profiles, current segment product reviews, Aspirational segment product reviews, current segment service reviews, Aspirational segment service reviews, forecasted sales based on current segment, forecasted sales based on aspirational segment, current offers by promoter competitors, current offers by promoter, previous promotions by promoter, previous promotions by competitor of promoter, regional economic statistics, national economic statistics, international economic statistics, product tariffs, logistics costs, product perish ability, product obsolescence, product shrinkage (theft etc.), product usage, product repairs, product quality, product life expectancy, product life cycle, advertising support, advertising timing, seasonality.

With the recommendation, promoter determines 903 which segments and products should receive specific promotions. For instance, promoter may determine that one product should receive a price discount, another product should receive a purchase incentive, yet another product should receive a discount, a purchase incentive and advertising support from the system. There is no limit to the potential promotions that a product or service may receive nor is there a limit to the number of potential combinations that are available to the promoter. A promoter's options may include but are not limited to: item price discounts, item group discounts, rebates, rewards, gift with purchase, buy one get one a percentage off, buy one get one free, lease discounts, special credit, special interest rate terms, special interest time terms, delayed payment terms, future trade terms, special warranty terms, extended warranty terms, guarantees on product's ability to be recycled, or product end of life return terms.

The system applies the promoter's promotions 904 to the appropriate segments. This application generates an offer ID which is specific to the individual product or service, the segment, the promotion, the promoter, and the promotion time frame. Offer ID 904 may also include restrictions made on the offer. Restrictions may include but are not limited to, quantity restrictions, frequency restrictions (i.e. only one discount per week etc.) geographic or regional restrictions, retailer restrictions (i.e. offer only available at specific retailer etc.), time of purchase restrictions, time of receipt restrictions, or method of purchase restrictions (i.e. must use credit card to purchase etc.) In one embodiment application of promotions and offer ID creation occurs simultaneously as the promoter approves or determines the promotions. In another embodiment, the promoter is able to view a running estimate of the promotional costs based on the systems estimates of sales. This enables the promoter to make adjustments in real time to test different scenarios and help ensure that both revenue budget targets and expense budget targets are met. In another embodiment, of application of promotions and offer ID creation the updates to the system are done in batch mode and then reported back to the promoter. In another embodiment, the system reviews the promoter's strategy and makes new suggestions to help the promoter maximize revenue, maximize profitability, or minimize cost. In one embodiment a linear program algorithm is used by the system to help optimize decisions for the promoter. In another embodiment a non-linear program is used to help optimize decisions for the promoter. In another embodiment stochastic programming is used to help optimize decisions for the promoter. In another embodiment dynamic programming is used to help optimize decisions for the promoter. Some embodiments may also use multi-objective optimization to simultaneously optimize a plurality of conflicting objectives.

Results may be gathered on the promoter strategies 905. When system users interact with the system these results are identified, captured, stored and may be reported upon. This allows promoters and others to determine the effectiveness of their various strategies. Examples of results that may be captured include but are not limited to: response rate of promotion, number of individuals viewing promotion, number of impressions from promotion, percent of segment members using the promotion, number of segment members using the promotion, segment summarized comments on the promotion or promotion's perceived effectiveness, individual comments on promotion or promotion's perceived effectiveness, total cost of promotion, total cost of promotion compared to estimated cost, total sales increase due to promotion, total profitability increase due to promotion, number of new product or service users due to promotion, number of segment users not using promotion, product warranties completed due to promotion, individuals with a product warranty due to promotion, or promotional success compared to competitor's promotional success.

There are no limits to the number of combinations of reports that may be created. Reports may be generated for any one or combination of groupings including but not limited to reports; by individual, by segment, by group of segments, by promoter, by competitor, by cost, by product, by group of products, by industry, by time, by calendar date, by time series, by region, by state, by locality, by distribution channel, by discount or reward type, or another grouping that may be gathered

FIG. 10 illustrates an example group of segmentation discounts FIG. 10 expands on FIG. 9. In one embodiment, the system recommends potential offers 902. FIG. 10 is illustrative of what a promoter may see for a custom category of white wine. In this illustration the promoter represents a white wine distributer. One skilled in the art will realize that there are unlimited numbers of custom categories that may be reviewed by a promoter. If the distributer in this example were a red wine distributer, he would have completely different recommendations to consider for promotion. FIG. 10 continues with three of the four example aspirational segments found in FIG. 8. In FIG. 10 the system has analyzed the various segment profiles and identified white wines to which each segment has expressed an affinity. In one embodiment, a system determines the products to consider for promotion based on segment preferences gathered in Individual Segmentation System 214 (FIG. 2) and using Segment Administration Module 325 (FIG. 3). In one embodiment users preferences and reviews are identified. These preferences are summarized by segment and favorite products and services are identified. In another embodiment, Individual Segmentation System 214 uses the Results Module 329 (FIG. 3) to identify actual purchases made through the system. Results Module 329 takes this information and uses algorithms to forecast potential preferences for the segment. In another embodiment, Individual Segmentation System 214 uses the Results Module 329 to identify discounts and/or rewards for products selected by users of the system. Results Module 329 takes this information and uses algorithms to forecast potential preferences for the segment. In another embodiment, Individual Segmentation System 214 uses the Results Module 329 to identify the value of discounts and/or rewards for products selected by users from the system. Individual Segmentation System 214 determines what level of reward or discount is necessary to encourage a given segment to take or use a promotion. Results Module 329 takes this information and uses algorithms to forecast potential preferences for the segment. In yet another embodiment, Individual Segmentation System 214 uses the Results Module 329 to identify warranties for products created by users of the system. Results Module 329 takes this information and uses algorithms to forecast potential preferences for the segment. Individual Segmentation System 214 may use any mathematical tools to arrive at the selected segment items and suggested promotional values. These mathematical tools may include but are not limited to; addition, multiplication, linear regression, non-linear regression, linear programming, non-linear programming, time series forecasting, dynamic programming, or stochastic programming. Mathematical tools may be used individually or may be used in any combination.

FIG. 10 illustrates the Jane Segment 1000 and three potential white wines that the Jane Segment prefers. The system has generated a recommended discount of $1.50 per bottle 1001 for Chablis, which based on segment calculations should encourage Jane Segment 1000 members to consider purchasing a Chablis. The system has also generated a recommended discount of $0.50 per bottle 1002 for Chardonnay, which based on segment calculations, should encourage Jane Segment 1000 members to consider purchasing Chardonnay. Another feature of the system is shown in 1003. The system may use dollar discounts, percent discount and a multitude of reward (as delineated above) in each promotion. For the Chenin Blanc, the system has also generated a recommended discount of 20% per bottle 1003, which based on segment calculations, should encourage Jane Segment 1000 members to consider purchasing Chenin Blanc wine.

For this illustration, The Mary Segment 1004 has similar white wines that are being recommended for discount, but the discounts are markedly different than the Jane Segment 1000 white wines. This is because the system has determined that different wines require different discounts for the Mary Segment 1004 promotions to be successful. The suggested Chablis discount for the Mary Segment 1004 is a 5% discount 1005. The suggested Chardonnay discount for the Mary Segment 1004 is a $1.00 per bottle discount 1006. The Mary Segment's 1004 next suggested discount is for a Gewurztraminer white wine. The system suggests a 15% discount 1007 to encourage the Mary Segment 1004 to purchase Gewurztraminer wine.

For this illustration the Kristen Segment 1008 the discounts are markedly different than the Jane Segment 1000 and the Mary Segment 1004 white wines. This helps illustrate that the system may calculate different recommended discounts for each segment. Products or services recommended for promotional consideration may change in addition to discounts and rewards. The suggested Chardonnay discount for the Kristen Segment 1008 is a 10% discount 1009. The suggested Rhine wine discount for the Kristen Segment 1008 is a 5% per bottle discount 1010. The Kristen Segment 1008 final suggested discount is for a Gewurztraminer white wine. The system suggests a $2.50 discount 1011 to encourage the Kristen Segment 1008 to purchase a Gewurztraminer wine.

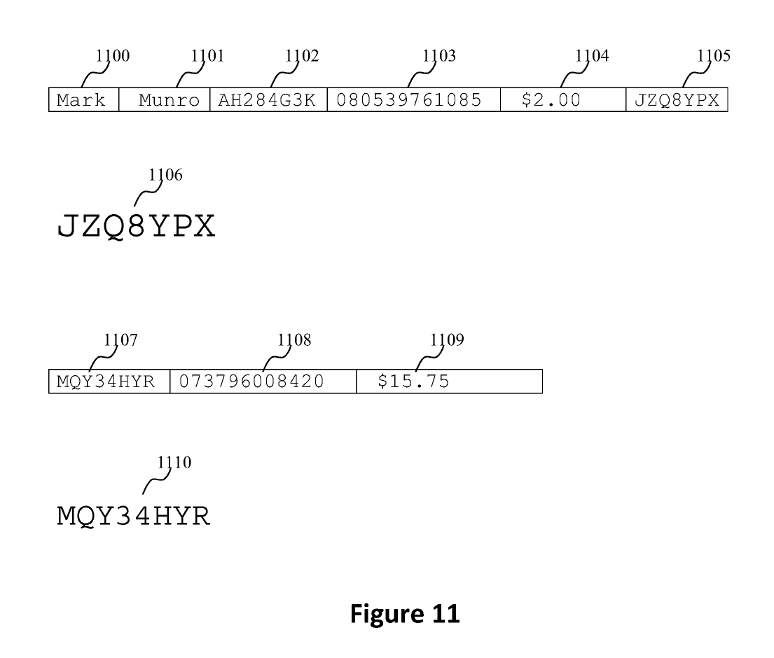

FIG. 11 illustrates an example output for one embodiment. In this embodiment individual user information is important. For this example, system creates a code for later purchase 508 (FIG. 5). The system user's first name Mark 1100 is identified as a result of the user's log in to the system. In the same manner as the user's last name Munro 1101 is identified from the system. The system generates a special offer code AH284G3K 1102 when the user selects an offer. This code is offer specific and is created in offer ID 904 (FIG. 9). The product Universal Product Code UPC 080539761085 is also captured 1103. The valuation of the promotional offer (discount or reward) 1104 is listed as $2.00. The specific transaction code 1105 is listed as JZQ8YPX. Special transaction code 1105 is a code that will provide a linking mechanism to individual user id, specific system transaction and offer ID 904 (FIG. 9). Special transaction code 1105 may also include, other user information, user's time of access, day of offer, time of offer, valuation of offer. Special transaction code 1105 may also include transaction restrictions or limitations. Output of special transaction code 1105 may be in many forms and formats. In this example, special transaction code 1105 is output as a barcode 1106. The barcode is a convenient output that may be printed by user. Since nearly all retailers have barcode readers, one embodiment uses standard retail barcodes and existing retail technology to read the barcode. Barcode may be any type of barcode including but not limited to, 2d Barcode, 3d Barcode, Code 39, Code 25, Code 93, Code 128, Semacode, Aztec Code, or QR Code. Special transaction code 1105 may also be output in many different formats including but not limited to infrared codes, audio codes, analog codes, wireless digital codes, RFID codes, magnetically encoded codes, or pen and paper codes.

In one embodiment, individual user information is not important. In this embodiment the user may take advantage of offers in an anonymous manner. The system generates special offer code MQY34HYR which is seen in 1107 for the product number with UPC number 073796008420 is also captured 1108. The discount $15.75 is applied 1109 to the product when the user selects an offer. In this embodiment, the barcode output 1110 represents the anonymous special offer code. This code may be formatted in a retail readable format which would facilitate scanning and usage with standard retail scanning technology. Anonymous transaction code 1107 could also be output in any type of barcode including but not limited to, 2d Barcode, 3d Barcode, Code 39, Code 25, Code 93, Code 128, Semacode, Aztec Code, or QR Code. Anonymous transaction code 1107 may also be output in many different formats including but not limited to infrared codes, audio codes, analog codes, wireless digital codes, RFID codes, magnetically encoded codes, pen and paper codes.

FIG. 12 illustrates an example process for matching a customer to a new segment and creating an aspirational segmentation for a user The Individual Segmentation System 214 (FIG. 2) creates codes 1200 for an individual user based on the users selection of offers. 1105 (FIG. 11) is an illustrative example of such a code. Customer uses the code to obtain a discount and/or reward, 1201 (FIG. 12). When code is used, retailer captures code usage and passes code usage 1202 to the Individual Segmentation System 214 (FIG. 2). The Individual Segmentation System 214 (FIG. 2) tracks user's product and service preferences 1203 over time. In one embodiment the system records all transaction data by user and by time. At predetermined times, Individual Segmentation System 214 (FIG. 2) compares product usage 1203 and preferences to segments 1204 to look for similarities between the user's transactions and preferences to at least one segment. System then identifies new segment and new aspirational segment. In one embodiment, Individual Segmentation System 214 (FIG. 2) determine segment by calculating a percentage match of user transactions with segment transactions and aspirational segment transactions.

In another embodiment, Individual Segmentation System 214 (FIG. 2) looks for trends in individual purchases and forecasts segment migration using forecasting techniques. System calculates current segment migration path and calculates potential new aspirational segments. In another embodiment, Individual Segmentation System 214 (FIG. 2) looks for trends in product reviews and forecasts segment migration using forecasting techniques. System calculates current segment migration path and calculates potential new aspirational segments, 1205.

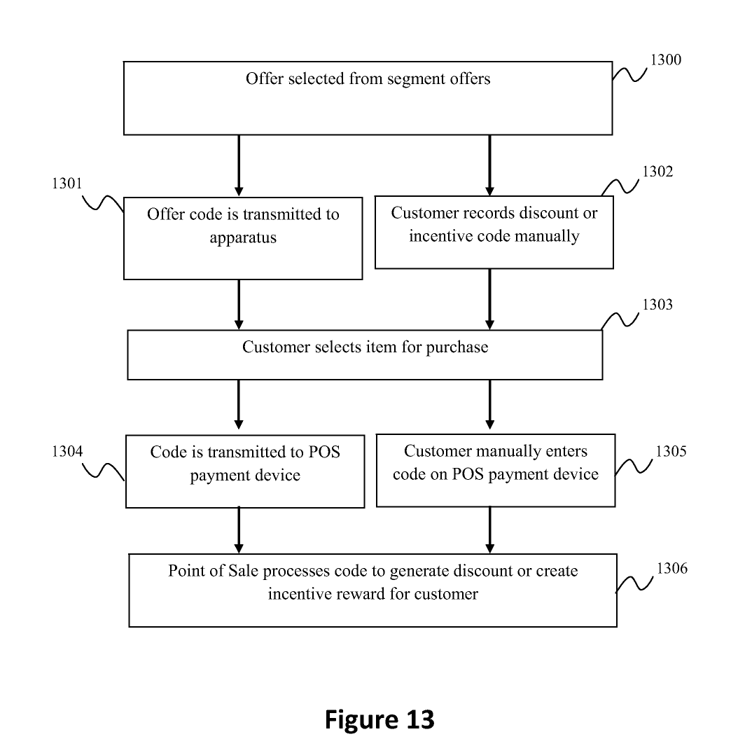

FIG. 13 illustrates an example process for transmission of offers to a user. At least one offer comprised of product or service discount, rewards or promotions is selected from a segment offer for later purchase 1300. In one embodiment, after the offer is selected, the offer code may be transmitted to an output apparatus 1301. Apparatus may include but is not limited to a monitor, a printer, an Personal Digital Assistant PDA, a cell phone, a portable USB drive, a floppy disk, an optical disk, a memory card, a computing device, a magnetic stripe, and RFID chip, a memory chip, or any other apparatus that would enable a code to be stored. In another embodiment, a user simply records the offer code manually 1302 such as by writing down the code on a piece of paper. The customer selects the offer item for purchase 1303 at an appropriate retailer or seller outlet. In one embodiment the seller transmits the offer code 1304 to the Point of Sale (POS) payment device.

In this embodiment, transmission can be accomplished in many ways including but not limited to; scanning a printed barcode such as 1106 or 1110 (FIG. 11), wireless transmission through a Bluetooth or similar device, wireless transmission from a cell phone, wireless transmission from a PDA, Infrared transmission, plugging a portable USB drive into an apparatus, swiping a magnetic stripe, moving an RFID device within range of a scanner, deploying a memory chip, deploying a floppy disk, deploying an optical disk, deploying a memory card or any other method that would enable the Point of Sale system to acquire the offer code. In another embodiment customer enters the offer code onto a POS payment device, 1305. Such devices include, a keyboard, a keypad, a personal identification number (PIN) input pad or another input devices that would enable a customer to manually enter the offer code. After receiving the offer code, the Point of Sale system processes 1306 the code and generates the appropriate discount, incentive or reward for the customer.

In another embodiment the apparatus contains a Trusted Platform Module (TPM). The TPM brings additional security to the apparatus because each TPM has a unique TPM signature, much like a fingerprint. Since no two TPM's will be the same, this uniqueness enables additional security for the apparatus. Offer codes can be uniquely attached to a specific apparatus which contains a TPM, enabling real-time identification of the apparatus and ensuring that POS code processing and approval are expedited.

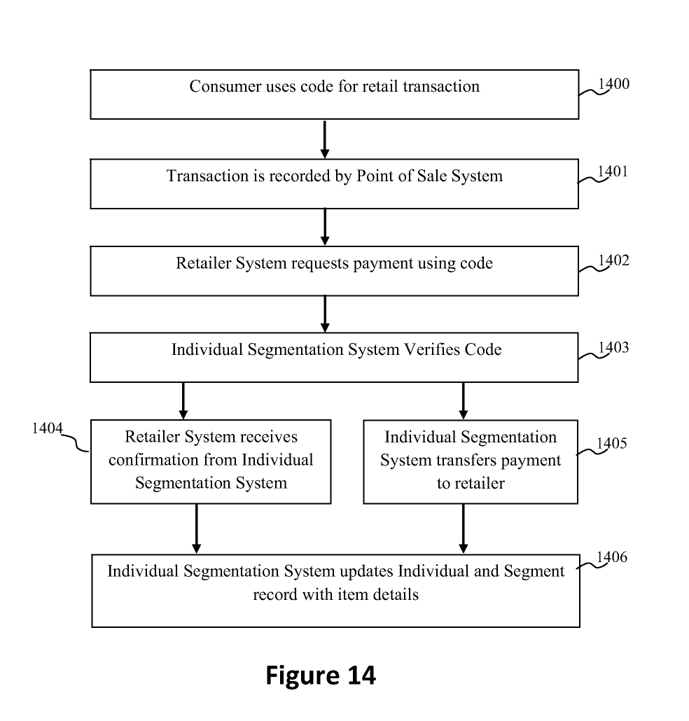

FIG. 14 illustrates an example process for code approval and offer fulfillment. When a consumer uses an offer code for a retail transaction 1400, a number of things occur to ensure that the consumer receives the appropriate discount, reward or incentive from the offer and the retailer receives appropriate payment for honoring the offer. The transaction is recorded 1401 by the retailer's point of sale system. In one embodiment, the retailer's system records the item Universal Product Code (UPC) number for the item that the customer is purchasing. This UPC number is sent along with the offer code to the Individual Segmentation System 50 (FIG. 1) by way of the communication network 15 (FIG. 1). The retailer requests payment by using this code 1402. The segmentation system verifies the offer code and the UPC associated with the offer code, 1403. If the code and UPC are verified, the retailer receives confirmation 1404 from the individual segmentation system 50 (FIG. 1). In one embodiment, payment is sent in real time to retailer upon receiving confirmation 1404. In another embodiment retailer receives payment at a later time. Individual Segmentation System transfers payment to retailer 1405, shows how payment can be separated from approval. Payment may be sent to retailer through a number of methods which include, but are not limited to; electronic transfer through the credit card payment network, electronic transfer through the debit card payment network, electronic transfer through the ACH payment network, electronic payment through wire transfer, electronic payment through bank to bank dedicated line transfer, a dedicated Individual Segmentation System payment network, sending a check to the retailer. Once the transaction has been approved the Individual Segmentation System updates individual and segment records 1406 with item details. These details may include, but are not limited to; item name, item number, serial number, UPC number, quantity, price, offer number, individual name, segment name, segment number, item description, retailer name, retailer location, time of day, date, or any information that is gathered from a transaction.

In one embodiment, a computer executed method for paying for products or services includes using a code to enable a user purchase. A transaction at a point of sale device is recorded. Payment approval is requested using the code. The validity of the code is verified for a specific user, and the payment amount is confirmed using said code. Finally, the confirmed amount is paid to the seller, completing the transaction.

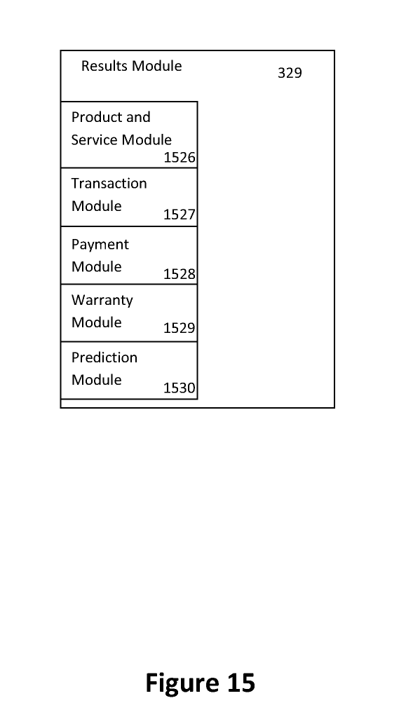

FIG. 15 illustrates example sub-modules of Results Module 329. Results Module 329 may further include Product and Service Module 1526 which uses inputs to identify products that are part of a promotional offer. Product and Service Module 1526 also creates, modifies and maintains item level and segment level result information, Transaction Module 1527 uses inputs to create, modify and maintain transaction level information. This transaction level detail may include but is not limited to, item name, item number, item description, serial number, UPC number, retailer name, retailer location, time of day, date, quantity, price, offer number, individual name, segment name, segment number, or any information that is gathered from a transaction. Payment Module 1528 creates, modify and maintains information regarding payments made by the Individual Segmentation System 214 (FIG. 2). In one embodiment, Payment Module 1528 matches offer code to eligible item, approves payment, processes and facilitates payments made to retailers as a result of segment promotions.

Warranty Module 1529 gathers information from other modules to complete product or service warranties for system users. Warranty Module 1529 gathers product information from Product and Service Module 1526, and transaction module 1527, and user information from Segment Administration Module 329 to complete product warranty information for the system user. This feature should help users make sure that products or services purchased receive the full benefit of a warranty. This feature helps manufacturer ensure that they can identify users of their products and services. This is especially valuable to both when product recalls are required. The safety of the product user is protected, and the liability of the manufacturer may be limited.

Prediction Module 1530, gathers information from a plurality of sources to facilitate future product demand predictions. Since the Individual Segmentation System 214 (FIG. 2) has access to transaction data which includes buying behavior by: segment and individual, location, item, date, price and quantity, one skilled in the art will see that predicting future purchases is possible. Prediction Module 1530 gathers: item information from Product and Service Module 1526, item, location, date, price and quantity information Transaction Module 1527, and segment and individual information from Segment Administration Module 329 (FIG. 3). Prediction Module 1530 uses mathematical algorithms to predict future buying patterns. Mathematical algorithms may include but are not limited to, linear regression, nonlinear regression, partial least squares regression, data mining, gravity modeling or any other mathematical algorithm that may be used to forecast future buying patterns. Results module 329 stores information in Results 218 (FIG. 2)

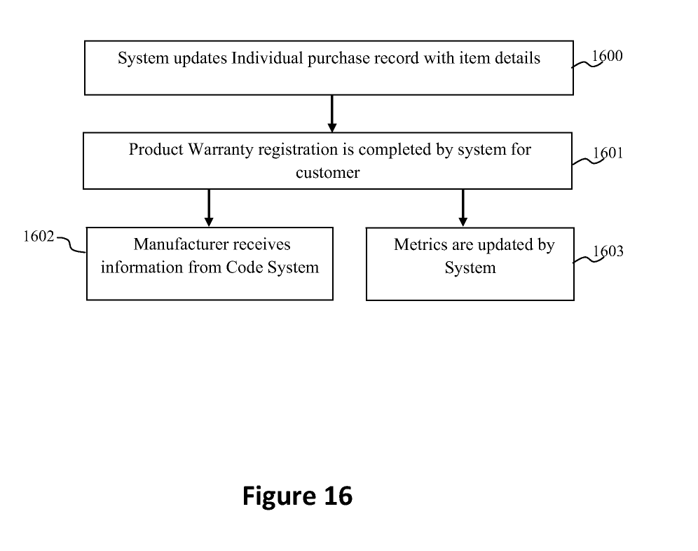

FIG. 16 illustrates an example process for warranty registration. Once a product has been purchased by a customer the Individual Segmentation System 214 (FIG. 2) updates the individual's purchase record 1600 with item level details that include: item information from Product and Service Module 1526 (FIG. 15), item, location, date, quantity information Transaction Module 1527 (FIG. 15), and segment and individual information from Segment Administration Module 325 (FIG. 3). In another embodiment, item serial number may also be gathered from Transaction Module 1527 (FIG. 15). Individual Segmentation System 214 (FIG. 2) completes the product warranty registration 1601 (FIG. 16) for the benefit of the customer using the information gathered in 1600. The manufacturer is then sent the warranty registration 1602 through Communication Network 15 (FIG. 1). In one embodiment, metrics are updated by system 1603 immediately. In another embodiment, metrics are updated by system 1603 at some later time.

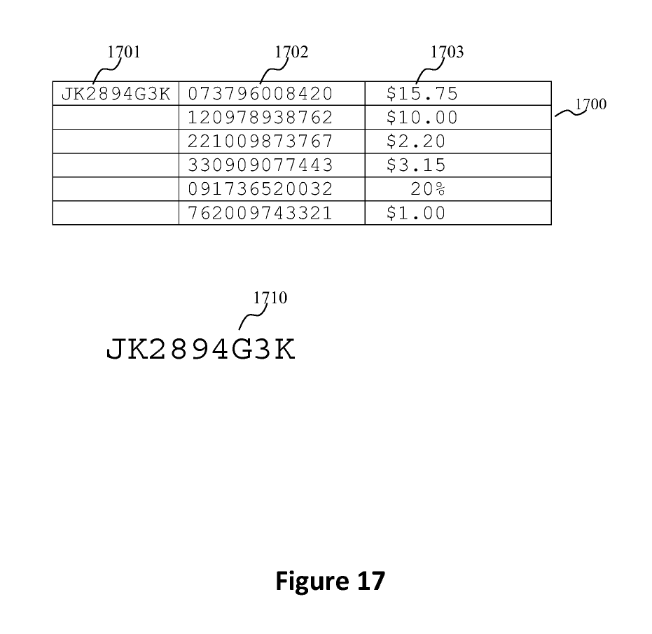

FIG. 17 illustrates an example output enabling the consolidation of offer codes for one embodiment. For this embodiment, output may be a result of System creates code for later purchase 508 (FIG. 5). In this example, the various items and item discounts 1700 the user has selected have been consolidated into one Consolidated Transaction Code 1701. Individual UPC codes are still listed such as 1702, along with individual line item prices such as 1703. In one instance, a user may want to use a consolidated transaction code when said user is certain of the products or services he will be buying. In another instance, a user may want to use a Consolidated Transaction Code 1701 when all the items are part of a package deal offered by a promoter or plurality of promoters. In another instance, a user may want to use a Consolidated Transaction Code 1701 when the items are part of a kit purchase. Consolidated Transaction Code 1701 is a code that will provide a linking mechanism to individual user, specific system transaction and offer ID 904 (FIG. 9). Consolidated Transaction Code 1701 may also include, other user information, users time of access, day of offer, time of offer, valuation of offer. Consolidated Transaction Code 1701may also include transaction restrictions or limitations. Output of Consolidated Transaction Code 1701 may be in a number of forms and formats. In this example, Consolidated Transaction Code 1701 is output as a barcode 1710. The barcode is a convenient output that may be printed by user. Since nearly all retailers have barcode readers, one embodiment uses standard retail barcodes and existing retail technology to read the barcode. Barcode may be any type of barcode including but not limited to, 2d Barcode, 3d Barcode, Code 39, Code 25, Code 93, Code 128, Semacode, Aztec Code, or QR Code. Consolidated Transaction code 1701 may also be output in many different formats including but not limited to infrared codes, audio codes, analog codes, wireless digital codes, RFID codes, magnetically encoded codes, pen and paper codes.

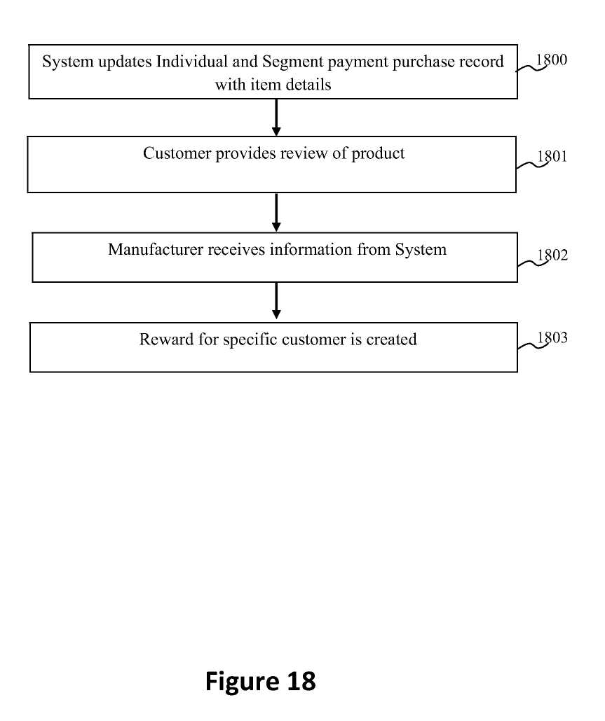

FIG. 18 illustrates an example process for reward creation and modification. Manufacturers, retailers and others value feedback on their products and services. Unfortunately, many times customers do not want to provide product feedback directly to these entities out of fear, or for any number of different reasons. The system allows users to provide feedback as either anonymous or named individuals and receive a reward for providing the feedback. Since the system has documented the purchase, manufacturers retailers and others can be assured that the feedback is coming from a documented buyer.

Once a product or service has been purchased by a customer, the Individual Segmentation System 214 (FIG. 2) updates the individual's purchase record 1800 with item level details that include: item information from Product and Service Module 1526 (FIG. 15), item, location, date, quantity information Transaction Module 1527 (FIG. 15), and segment and individual information from Segment Administration Module 325 (FIG. 3). Customer may then use Individual Segmentation System 214 (FIG. 2) to create a review of the product or service 1801 based on his personal experiences. Customer may choose to send feedback anonymously. System then sends the manufacturer or service provider the product or service review 1802 through Communication Network 15 (FIG. 1). A reward 1803 for creating the review is then sent to the customer who created the review. Said reward may be of any type including, but not limited to, cash, credit, product, service, promotional credit or any other valuable consideration.

In one embodiment, the system takes the individual results from a purchase transaction and rolls it into the individual's segment. Since the system now is aware of the size and type of the offer that enticed the customer to purchase the product or service, the system can factor this information into any new calculations for future offers. For example, if the system receives data that only 100 customers accepted an offer to buy Rhine wine at a 10% discount, whereas 3600 people accepted an offer and bought Rhine wine at a $2.00 off discount, the system will adjust its criteria for the segment. System may then suggest a new offer to a wine promoter that may include a dollar discount for the segment instead of a “percent off' offer for the segment. The system may also suggest a specific dollar value for an offer. One skilled in the art will understand that the system will be able to refine promotional strategies continually, and essentially “learn” how to improve offers with each transaction.

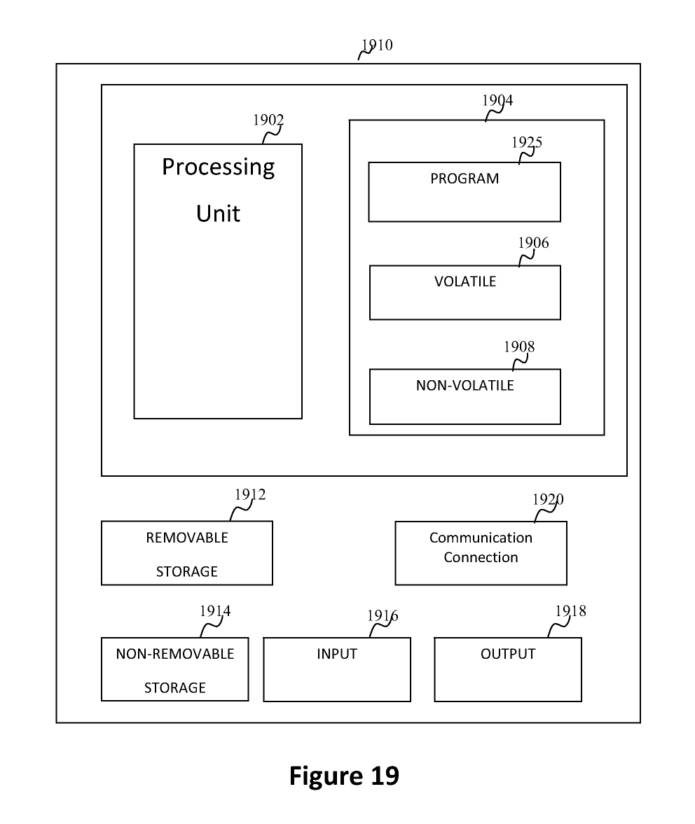

A block diagram of a computer system that executes programming for performing the above algorithms is shown in FIG. 19. A general computing device in the form of a computer 1910, may include a processing unit 1902, memory 1904, removable storage 1912, and non-removable storage 1914. Memory 1904 may include volatile memory 1906 and non-volatile memory 1908. Computer 1910 may include—or have access to a computing environment that includes—a variety of computer-readable media, such as volatile memory 1906 and non-volatile memory 1908, removable storage 1912 and non-removable storage 1914. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 1910 may include or have access to a computing environment that includes input 1916, output 1918, and a communication connection 1920. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 1902 of the computer 1910. A hard drive, CD-ROM, and RAM are some examples of articles including a computer-readable medium.

In one embodiment, a system and method match user inputs with other similar user inputs to create a segment of users such that offers, promoters have created for the segment, may be used to purchase products or services. In a further embodiment, a system and method matches real time purchase data with available offers and then approves and pays on these offers. In a further embodiment, transaction data is combined with system user data to complete product warranty registration for the user. In a further embodiment users receive a reward for providing anonymous feedback to a manufacturer, retailer or promoter on a recent transaction.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

What is claimed is:

1. A device comprising:
an input apparatus to facilitate identification and recording of preferences for individuals;
a presentation node to perform content, promotions and advertisements;
a content provider node to distribute or receive content or promotions to a network;
a sellers node to process transactions and pass transaction data to the network
a system using for creating product discounts and rewards for customers, said system matching customer preferences with other users preference, said system creating a segment of a plurality of users, said system using promoter's preferences for creating offers for products and services, said system selects and inserts said item's promotional offer value in content such that the presentation node performs the promotional content.

2. The device of claim 1 wherein at least one node contains Trusted Platform Module (TPM).

3. The device of claim 1 wherein the network used for the distribution of content is satellite based.

4. The device of claim 1 wherein the network used for the distribution of content is cable based.

5. The device of claim 1 wherein the network used is fiber optic based.

6. The device of claim 1 wherein the network is electro-magnetic wave based.

7. A computer executed method comprising:
gathering responses from the at least one individual;
comparing and matching responses to a segment of at least one unknown person who shares similar tastes and has similar personalities;
identifying products that may be interesting to the at least one individual;
offering the product or service immediately for purchase to the at least one individual;
offering a code for a later purchase to the at least one individual; and
providing a discount, reward or incentive as a function of the identification of personal tastes and individual personality of the at least one individual.

8. The method of claim 7 wherein the code is sent to an electronic device.

9. The method of claim 7 wherein at least one reward is offered to the at least one individual.

10. The method of claim 7 wherein at least one incentive is offered to the at least one individual.

11. The method of claim 7 wherein the at least one individual registers ownership of the at least one product or service.

12. The method of claim 7 wherein the at least one individual reviews or rates the at least one product or service.

13. A computer executed method of identifying aspirational lifestyles, products or services of at least one individual the method comprising:
gathering responses from the at least one individual;
linking current responses to previous responses of the at least one individual;
comparing and matching responses to a segment of at least one unknown person who shares similar tastes and/or a similar personality;
forecasting lifestyle changes for the at least one individual;
identifying potential future lifestyle segmentations for the at least one individual;
identifying at least one product or service for the at least one individual;
offering the at least one product or service immediately for purchase to the at least one individual;
offering a code for a later purchase of at least one product or service to the at least one individual.

14. The method of claim 13 wherein the code is sent to an electronic device.

15. The method of claim 13 wherein at least one reward is offered to the at least one individual.

16. The method of claim 13 wherein at least one incentive is offered to the at least one individual.

17. The method of claim 13 wherein the at least one individual registers ownership of the at least one product or service.

18. The method of claim 13 wherein the at least one individual reviews or rates the at least one product or service.

19. A computer executed method for enabling at least one seller to create discounts, rewards or incentives for at least one good or service the method comprising:
identifying personal tastes for at least one segment to receive discount, reward or incentive;
identifying a propensity to purchase the at least one good or service for the at least one segment;
determining at least one good or service for discount, reward or incentive;
assigning discount, reward or incentive to the at least one good or service;
linking the discount and the at least one good or service using alphanumeric or digital codes;
storing the discount, reward or incentive and the linked codes such that the discount and linked codes are accessible by a user.

20. A computer executed method for measuring the effectiveness of assigned discount, rewards or incentives the method comprising:
gathering responses from user purchases;
grouping the responses by predefined categories;
calculating a return on the discount, reward or incentive investment.

21. A computer executed method for completing a warranty registration, the method comprising:
gathering transaction details from user purchase;
matching user's purchases with user data;
combining purchasing data with user data;
completing a warranty registration for a product or service;
providing the registration to a manufacturer or service provider.

22. A computer executed method for providing feedback on at least one product or service, the method comprising:
gathering transaction details from user purchase;
gathering user's review of product or service;
combining purchasing data with user data;
providing the registration to a manufacturer or service provider.

23. The method of claim 22 wherein the feedback is done without revealing the user's identity (anonymously).

24. The method of claim 23 wherein the anonymous user receives a reward for providing feedback.

25. An apparatus to create and use Individual Segmentation content, the apparatus comprising:
an input device that enables a user to select or input preferences into an Individual Segmentation system;
a calculation component that determines a potential segmentation from a plurality of inputs;
a storage device;
a processing unit that identifies at least one product offer for the segmentation;
an inserting device that places promotions in a Point of Sale (POS) system.

26. The apparatus of claim 25 wherein the apparatus contains a Trusted Platform Module (TPM).

27. A computer executed method for paying for products or services, the method comprising:
using a code to enable a user purchase;
recording a transaction at a point of sale device;
requesting payment approval using said code;
verifying the validity of said code for a specific user;
confirming payment amount using said code;
paying amount confirmed to seller.
